(19) United States
(12) Patent Application Publication
(10) Pub. No.: US 2017/0118572 A1
(43) Pub. Date: Apr. 27, 2017

(54) ENVIRONMENTAL SOUND SOURCE RECOGNITION SYSTEM AND ENVIRONMENTAL SOUND SOURCE RECOGNIZING METHOD THEREOF

(71) Applicants: SAMWEL TESTING INC., New Taipei City (TW); Signal-Wise, LLC, Troy, MI (US)

(72) Inventors: XUAN-LOC NGUYEN, New Taipei City (TW); JIN-LIANG CHEN, New Taipei City (TW); SHAU-SAN WU, New Taipei City (TW); YA-ZHONG LU, Troy, MI (US)

(21) Appl. No.: 15/331,037

(22) Filed: Oct. 21, 2016

(30) Foreign Application Priority Data
Oct. 22, 2015 (TW) 104134752

(51) Int. Cl. H04S 7/00; H04N 13/02; H04R 5/027

(52) U.S. Cl. CPC H04S 7/40; H04R 5/027; H04N 13/0203; H04S 2400/11

(57) ABSTRACT

An environmental sound source recognition system and an environmental sound source recognizing method thereof are disclosed. The system includes a plurality of sound sensing modules which are disposed in different planes for individually receiving a sound emitted by a target in order to obtain a plurality of sound sensing signals. A three-dimensional scanning device is used for scanning the environment to produce a three-dimensional environment image data. A signal recording module is used for recording the plurality of sound sensing signals and the three-dimensional environment image data. A processing module is used to calculate a location of the target based on the relative positions of the plurality of sound sensing modules and the plurality of sound sensing signals and to create a three-dimensional sound field according to the three-dimensional environment image data.

### BACKGROUND OF THE INVENTION

1. Field of the Invention

The present invention relates to an environmental sound source recognition system and an environmental sound source recognizing method thereof, and particularly to an environmental sound source recognition system capable of creating a three-dimensional sound field and an environmental sound source recognizing method thereof.

2. Description of the Related Art

With advances in science and technology, assistive devices for the disabled, such as hearing aids for the hearing impaired, are increasingly used in modern society. Currently, however, hearing aids for hearing impaired persons or other devices that detect sound can represent only the sound emitted in the current environment, and they cannot track the source of a fleeting sound or continuously track the trajectory of an object. The frequency or intensity of the sound cannot be detected; consequently, the use of the device for detecting the sound is restricted and the user cannot use the device for other extended applications.

Accordingly, it is necessary to develop a new environmental sound source recognition system and an environmental sound source recognizing method thereof to solve the deficiencies of the prior art.

### SUMMARY OF THE INVENTION

It is a major objective of the present invention to provide an environmental sound source recognition system which provides an effect of easily creating a three-dimensional sound field.

It is another objective of the present invention to provide an environmental sound source recognizing method used in the system described above.

To achieve the objectives above, the environmental sound source recognition system of the present invention is used for recognizing a target capable of emitting a sound. The environmental sound source recognition system includes a plurality of sound sensing modules, a three-dimensional scanning device, a signal recording module, and a processing module. The plurality of sound sensing modules are disposed in different planes for individually receiving the sound emitted by a target to obtain a plurality of sound sensing signals. The three-dimensional scanning device is used for scanning the environment to produce a three-dimensional environment image data. Specifically, the three-dimensional environment image data includes images of the target.

The signal recording module is electrically connected to the three-dimensional scanning device and the plurality of sound sensing modules for recording a plurality of sound sensing signals and three-dimensional environment image data. The processing module is electrically connected to the signal recording module and used to calculate a location of a target based on the relative positions of the plurality of sound sensing modules and the plurality of sound sensing signals and to create a three-dimensional sound field according to the three-dimensional environment image data.

The environmental sound source recognizing method of the present invention includes the following steps: using a plurality of sound sensing modules disposed in different planes for receiving a sound emitted by a target, in order to obtain a plurality of sound sensing signals; scanning the environment to produce a three-dimensional environment image data which includes images of the target; recording the plurality of sound sensing signals and the three-dimensional environment image data; and calculating a position of the target based on the plurality of sound sensing signals and the relative positions of the plurality of sound sensing modules; and creating a three-dimensional sound field according to the three-dimensional environment image data.

### BRIEF DESCRIPTION OF THE DRAWINGS

FIG. 1 is an architecture diagram of an environmental sound source recognition system in the present invention;

FIG. 2 is a schematic diagram showing the calculation of a target position in an embodiment of the present invention; and

FIG. 3 is a flowchart showing the steps of an environmental sound source recognizing method according to the present invention.

### DETAILED DESCRIPTION OF THE PREFERRED EMBODIMENT

Hereafter, the technical content of the present invention will be better understood with reference to preferred embodiments.

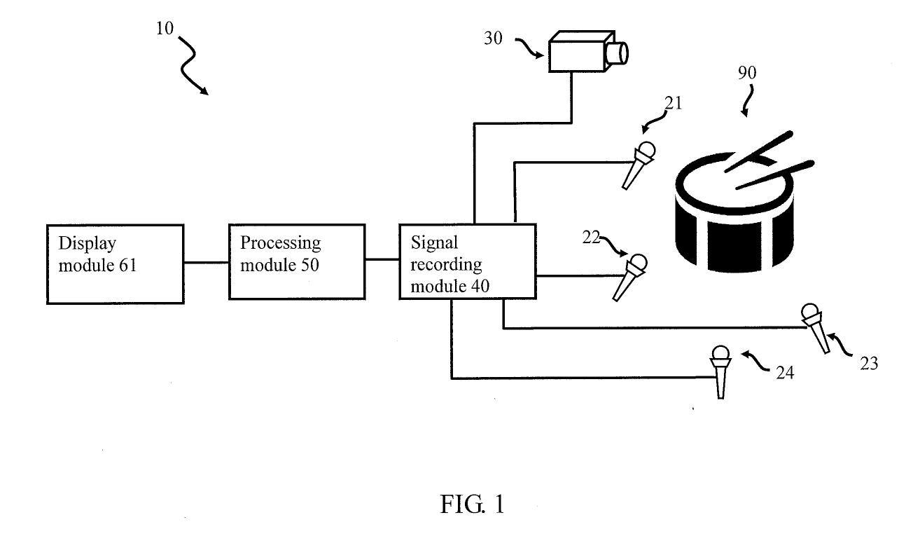

Hereafter, please first refer to FIG. 1, which is an architecture diagram of an environmental sound source recognition system according to the present invention.

The environmental sound source recognition system 10 of the present invention may be a computer system, a portable device or a wearable device used for recognizing the surrounding environment and a target 90 which can emit a sound, but the type of the target 90 is not limited by the present invention. The environmental sound source recognition system 10 includes a plurality of sound sensing modules, a three-dimensional scanning device 30, a signal recording module 40 and a processing module 50. The plurality of sound sensing modules may be high-sensitivity microphones. Also, in an embodiment of the present invention, the plurality of sound sensing modules may include a first sound sensing module 21, a second sound sensing module 22, a third sound sensing module 23 and a fourth sound sensing module 24, but the present invention is not limited to the number. The first sound sensing module 21, the second sound sensing module 22, the third sound sensing module 23 and the fourth sound sensing module 24 are individually disposed in different planes. When a sound is emitted by the target 90, the first sound sensing module 21, the second sound sensing module 22, the third sound sensing module 23 and the fourth sound sensing module 24 are used individually to receive the sound emitted by the target 90 in order to obtain a plurality of sound sensing signals. Specifically, the sound sensing signal may include a value such as a frequency, an occurrence time and a directional source of the detected sound, but the present invention is not limited thereto.

The three-dimensional scanning device 30 may be a non-contact active scanner or a non-contact passive scanner used for scanning the surrounding environment of the environmental sound source recognition system 10 to produce a three-dimensional environment image data. Specifically, the three-dimensional environment image data includes images of the target 90. The signal recording module 40 is a storage device with a storage function and is electrically connected to the three-dimensional scanning device 30 and the plurality of sound sensing modules. When the three-dimensional scanning device 30, the first sound sensing module 21, the second sound sensing module 22, the third sound sensing module 23 and the fourth sound sensing module 24 receive the three-dimensional environment image data and the plurality of sound sensing signals from the target 90, the signal recording module 40 records and saves the plurality of sound sensing signals and the three-dimensional environment image data.

Finally, the processing module 50 is electrically connected to the signal recording module 40 for reading out the required data from the signal recording module 40 to calculate three-dimensional coordinates of the target 90 based on the relative positions of the first sound sensing module 21, the second sound sensing module 22, the third sound sensing module 23 and the fourth sound sensing module 24 and the plurality of sound sensing signals. Finally, a three-dimensional sound field is created according to the three-dimensional environment image data. The three-dimensional sound field shows not only the position of the target 90 but also values such as the sound emitting number of the target 90, sound occurrence time, trajectory of the target 90, sound pressure level (SPL) or sound source intensity, but the present invention is not limited thereto. It should be noted that the first sound sensing module 21, the second sound sensing module 22, the third sound sensing module 23 and the fourth sound sensing module 24 may be arranged at predetermined positions. Thus, the processing module 50 can directly obtain the relative positions of the plurality of sound sensing modules for calculation. However, in another embodiment of the present invention, the three-dimensional scanning device 30 may be used to scan the first sound sensing module 21, the second sound sensing module 22, the third sound sensing module 23 and the fourth sound sensing module 24 to determine clearly the relative positions of the first sound sensing module 21, the second sound sensing module 22, the third sound sensing module 23 and the fourth sound sensing module 24. Therefore, the relative positions of the plurality of sound sensing modules can be arranged arbitrarily.

The environmental sound source recognition system 10 further includes a display module 61, which is electrically connected to the processing module 50 for informing users of the result calculated by the processing module 50 and using a three-dimensional image to mark the three-dimensional sound field calculated by the processing module 50, e.g., a position, a number, a sound occurrence time, trajectory, sound pressure level (SPL), frequency or sound source intensity of the target 90, for further statistical analysis.

It should be noted that each of the modules in the environmental sound source recognition system 10 may be configured as a hardware device, software programs with hardware devices, or firmware with hardware devices. For example, the signal recording module 40 and the processing module 50 may be components of an application product stored in a computer readable medium, and the three-dimensional scanning device 30, the first sound sensing module 21, the second sound sensing module 22, the third sound sensing module 23 and the fourth sound sensing module 24 may be external extension devices, or the above-mentioned modules may all be arranged in the same portable device or wearable device, but the present invention is not limited to the above-mentioned manner. In addition, the preferred embodiment of the present invention described here is only presented for illustrative purposes. To avoid redundancy, not all of the possible combinations of changes are documented in detail. However, it shall be understood by those skilled in the art that each of the modules or elements described above may not be necessary. For the implementation of the present invention, the present invention may also contain other detailed, conventional modules or elements. Each module or component may be omitted or modified depending on design requirements. Other modules or elements may not necessarily exist between any two of the modules.

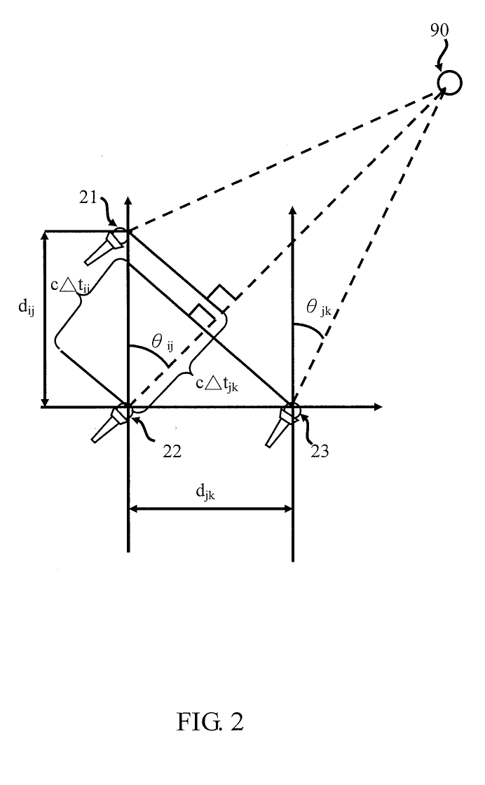

FIG. 2 is a schematic diagram showing the position calculation of a target in an embodiment of the present invention.

FIG. 2 illustrates the calculation method by presenting an example in which the first sound sensing module 21, the second sound sensing module 22, and the third sound sensing module 23 are in the same plane. However, the first sound sensing module 21, the second sound sensing module 22, and the third sound sensing module 23 are not limited to being in the same plane, and the present invention is not limited to only using this method to calculate the position of the target 90.

As shown in FIG. 2, when the first sound sensing module 21, the second sound sensing module 22, and the third sound sensing module 23 receive the sound from the target 90, the processing module 50 will calculate a position of the target 90 using the following formula:

θᵢⱼ=cos⁻¹(cΔtᵢⱼ/dᵢⱼ) and θⱼₖ=cos⁻¹(cΔtⱼₖ/dⱼₖ).

where θᵢⱼ is the angle between the first sound sensing module 21 and the second sound sensing module 22 to the target 90, dᵢⱼ is the straight-line distance between the first sound sensing module 21 and the second sound sensing module 22, and cΔtᵢⱼ is a relative distance of a right angle between the first sound sensing module 21 and the second sound sensing module 22 (θᵢⱼ). Similarly, θⱼₖ is an angle between the second sound sensing module 22 and the third sound sensing module 23 to the target 90, dⱼₖ is a straight-line distance between the second sound sensing module 22 and the third sound sensing module 23, and cΔtⱼₖ is a relative distance of a right angle between the second sound sensing module 22 and the third sound sensing module 23 (θⱼₖ). As such, after the angles θᵢⱼ and θⱼₖ are obtained, a position of the target 90 can be calculated. Also, in a three-dimensional space, the position of the target 90 can be calculated in other similar ways. Since the position of the object 90 can be calculated in many ways, the present specification is given by way of illustration only, and the present invention is not limited to this formula.

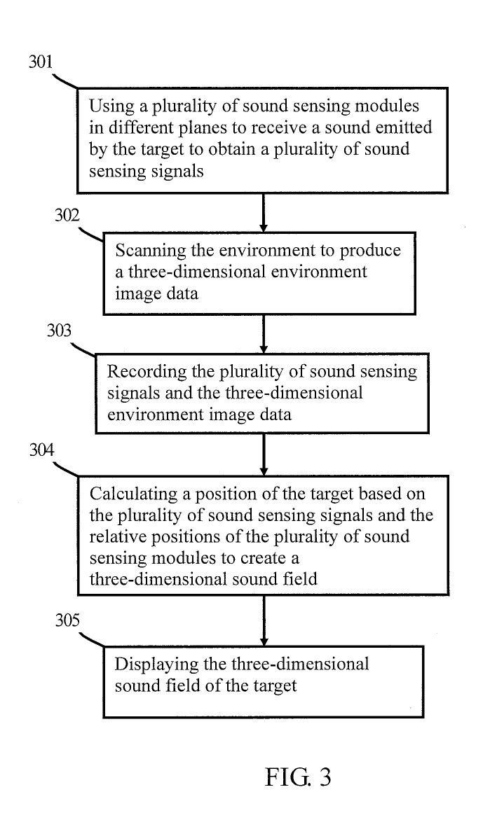

Now, please refer to FIG. 3, which is a flowchart of an environmental sound source recognizing method according to the present invention. It should be noted here that although the above-mentioned environmental sound source recognition system 10 is used as example to illustrate the environmental sound source recognizing method of the present invention, the environmental sound source recognizing method of the present invention is not limited to the environmental sound source recognition system 10 using a configuration identical to that described above.

First is Step 301: Using a plurality of sound sensing modules in different planes to receive a sound emitted by the target to obtain a plurality of sound sensing signals.

First, the first sound sensing module 21, the second sound sensing module 22, the third sound sensing module 23 and the fourth sound sensing module 24 disposed in different planes for receiving a sound emitted by the target 90 obtain a plurality of sound sensing signals.

Then is Step 302: Scanning the environment to produce a three-dimensional environment image data.

Next, the three-dimensional scanning device 30 scans the surrounding environment of the environmental sound source recognition system 10 to produce a three-dimensional environment image data. The three-dimensional environment image data also includes images of the target 90.

Then is Step 303: Recording the plurality of sound sensing signals and the three-dimensional environment image data.

After that, the plurality of sound sensing signals and the three-dimensional environment image data are recorded and stored in the signal recording module 40.

Next is Step 304: Calculating a position of the target based on the plurality of sound sensing signals and the relative positions of the plurality of sound sensing modules to create a three-dimensional sound field.

Then the processing module 50 is used to calculate three-dimensional coordinates of the target 90 based on the plurality of sound sensing signals and the relative positions of the first sound sensing module 21, the second sound sensing module 22, the third sound sensing module 23 and the fourth sound sensing module 24 to create a three-dimensional sound field according to the three-dimensional environment image data. The three-dimensional sound field represents not only the sound emitting device, namely, the position of the target 90, but also a position, a number, a sound occurrence time, trajectory, sound pressure level (SPL), frequency or sound source intensity of the target 90, but the present invention is not limited thereto.

Last is Step 305: Displaying the three-dimensional sound field of the target.

Last, the display module 61 can inform users of the three-dimensional sound field calculated by the processing module 50, such as by displaying a three-dimensional image to mark the position, number, sound occurrence time, trajectory, sound pressure level (SPL), frequency or sound source intensity of the target 90, for further statistical analysis.

It should be noted here that the environmental sound source recognizing method of the present invention is not limited to the sequence of steps described above. The order of the above steps may be changed as long as the functions and goals of the present invention can be achieved.

Thus, a three-dimensional sound field can be easily created, allowing the user to know the frequency, the occurrence time and the directional source of the sound and the three-dimensional sound field by means of vision, hearing, or touch.

It should be noted that the described embodiments are only preferred embodiments of the present invention. To avoid redundancy, not all the possible combinations of changes are documented in detail. However, it shall be understood by those skilled in the art that each of the modules or elements described above may not be necessary. For the implementation of the present invention, the present invention may also contain other detailed, conventional modules or elements. Each module or component may be omitted or modified depending on design requirements. Other modules or elements may not necessarily exist between any two of the modules, and various changes and modifications may be made to the described embodiment without departing from the scope of the invention as disposed by the appended claims.

What is claimed is:

1. An environmental sound source recognition system used for recognizing a target which can emit a sound, the environmental sound source recognition system comprising:
a plurality of sound sensing modules, which are disposed in different planes for individually receiving the sound emitted by the target to obtain a plurality of sound sensing signals;
a three-dimensional scanning device, which is used for scanning an environment to produce a three-dimensional environment image data that includes images of the target;
a signal recording module, which is electrically connected to the three-dimensional scanning device and the plurality of sound sensing modules for recording the plurality of sound sensing signals and the three-dimensional environment image data; and
a processing module, which is electrically connected to the signal recording module for calculating a position of the target based on the plurality of sound sensing signals and the relative positions of the plurality of sound sensing modules and for creating a three-dimensional sound field according to the three-dimensional environment image data.

2. The environmental sound source recognition system as claimed in claim 1, wherein the three-dimensional scanning device further scans the plurality of sound sensing modules to obtain the relative positions of the plurality of sound sensing modules.

3. The environmental sound source recognition system as claimed in claim 1, wherein the processing module further marks a trajectory of the target in the three-dimensional sound field.

4. The environmental sound source recognition system as claimed in claim 1, wherein the processing module further marks a sound occurrence time of the target in the three-dimensional sound field.

5. The environmental sound source recognition system as claimed in claim 1, wherein the environmental sound source recognition system comprises a display module for displaying the three-dimensional sound field using a three-dimensional image.

6. The environmental sound source recognition system as claimed in claim 1, wherein the plurality of sound sensing modules further detect a frequency, an occurrence time and a directional source of the sound.

7. An environmental sound source recognizing method used in an environmental sound source recognition system for recognizing a target capable of emitting a sound, the method comprising the steps of:
using a plurality of sound sensing modules disposed in different planes to receive the sound emitted by the target in order to obtain a plurality of sound sensing signals;
scanning an environment to produce a three-dimensional environment image data which includes images of the target;
recording the plurality of sound sensing signals and the three-dimensional environment image data; and
calculating three-dimensional coordinates of the target based on the plurality of sound sensing signals and the relative positions of the plurality of sound sensing modules, and creating a three-dimensional sound field according to the three-dimensional environment image data.

8. The environmental sound source recognizing method as claimed in claim 7, further comprising a step of obtaining the relative positions of the plurality of sound sensing modules by scanning the plurality of sound sensing modules.

9. The environmental sound source recognizing method as claimed in claim 7, further comprising a step of marking a trajectory of the target in the three-dimensional sound field.

10. The environmental sound source recognizing method as claimed in claim 7, further comprising a step of marking the sound occurrence time of the target in the three-dimensional sound field.

11. The environmental sound source recognizing method as claimed in claim 7, further comprising a step of using a three-dimensional image to display the three-dimensional sound field.

12. The environmental sound source recognizing method as claimed in claim 7, wherein the step of obtaining a plurality of sound sensing signals further detects a frequency, an occurrence time and a directional source of the sound.
